(19) United States
(12) Patent Application Publication
(10) Pub. No.: US 2026/0163752 A1
(43) Pub. Date: Jun. 11, 2026

(54) FACILITATING EFFICIENT MANAGEMENT OF LIVE MEETINGS

(71) Applicant: NVIDIA Corporation, Santa Clara, CA (US)

(72) Inventors: Shivi MISHRA, Bengaluru (IN); Amey KULKARNI, Bengaluru (IN); Mayank PANDEY, Bengaluru (IN); Priyanshu SHARMA, Bengaluru (IN); Prasun KUMAR, Bengaluru (IN); Harshraj RAO, Bengaluru (IN)

(21) Appl. No.: 18/974,376

(22) Filed: Dec. 9, 2024

(51) Int. Cl. H04L 12/18; G06F 40/35

(52) U.S. Cl. CPC H04L 12/1822; G06F 40/35; H04L 12/1831

(57) ABSTRACT

In various examples, systems and methods are disclosed related to performing generation of meeting insights for a live meeting using artificial intelligence (AI) technology. Such meeting insights may be in the form of inquiry responses that respond to an inquiry asked in a live meeting and/or orchestration directives that provide instruction or guidance for managing a flow of a live meeting. In embodiments, various data may be searched to identify contextual data for use in generating a meeting insight. For example, live meeting data, prior meeting data, and/or organizational data may be searched to identify contextual data relevant to a management event triggering generation of a meeting insight. The contextual data may then be used as input to a machine learning model, such as an LLM, VLM, or MMLM, to generate a corresponding meeting insight.

### BACKGROUND

Meetings are generally conducted to facilitate communication and collaboration among participants. In this regard, a meeting may be conducted to share information, brainstorm ideas, resolve issues, and make decisions. Oftentimes, however, facilitating a meeting may be difficult, thereby resulting in an ineffective meeting. In some cases, scrum meetings may be implemented in an effort to facilitate effective meetings. A scrum meeting generally refers to a meeting established to discuss progress, challenges, and plans in a team environment. Generally, scrum meetings follow a set structure with a focus to keep the team informed and identify obstacles that may hinder progress of a project or task. Typically, in conventional implementations, a human scrum manager manages a meeting in an effort to structure and focus a meeting. In this way, the scrum manager facilitates a collaborative meeting in an effort to schedule work, discuss ongoing work, and collect feedback, thereby promoting communication and team alignment.

Although scrum meetings provide a structured collaboration environment, effective management and addressing issues may remain challenging. As one example, a high volume of information may result in difficult meeting management. For instance, with a high volume of information, prioritizing tasks and information may be difficult to manage and align. Further, addressing or answering questions efficiently remains a challenge. Even with a team focus, information may be difficult to locate due to an extensive set of dispersed data sources, thereby resulting in diminished productivity and overlooked opportunities.

Further, conventional meeting implementations, such as scrum meetings, are oftentimes tedious and time consuming. For example, prioritizing tasks may consume time for the entire set of meeting participants to identify a prioritization of tasks. Further, in instances in which a question is asked, various meeting participants may individually search or gather information and, thereafter, the meeting participants may then deliberate to collectively consolidate or reason to arrive at a final answer, thereby consuming time of all the meeting participants. Further, such manual prioritization and response generation may result in erroneous project management, thereby producing an undesired result and unnecessary resource utilization.

In addition, such manual meeting management may require unnecessary utilization of computing resources. For example, various participants searching for a response to a question may result in multiple individuals utilizing computing resources (e.g., internet bandwidth, device processing power, and data storage) to perform redundant tasks. Further, erroneous prioritization of tasks and/or erroneous responses to inquiries can lead to errors or incomplete work, necessitating additional computing resources to correct or redo tasks later, thereby resulting in unnecessary computing resource utilization of disk space, I/O operations, CPU and memory usage, power consumption, among other things.

### SUMMARY

Embodiments of the present disclosure relate to facilitating efficient and effective management of live meetings. Systems and methods are disclosed that perform generation of meeting insights for a live meeting using artificial intelligence (AI) technology. Such meeting insights may be in the form of inquiry responses that respond to an inquiry asked in a live meeting and/or orchestration directives that provide instruction or guidance for managing a flow of a live meeting. In embodiments, various data may be searched to identify contextual data for use in generating a meeting insight. For example, live meeting data, prior meeting data, and/or organizational data may be searched to identify contextual data relevant to a management event triggering generation of a meeting insight. The contextual data may then be used as input to a machine learning model, such as language model (e.g., a large language model (LLM), a vision language model (VLM), a multi-modal language model (MMLM), etc.), to generate a corresponding meeting insight. Advantageously, and in accordance with embodiments described herein, the meeting may be managed, for example, in association with inquiry responses and meeting orchestration, in an automated manner, resulting in a timely and effective meeting.

In contrast to conventional implementations, performing automated meeting management using various contextual data (e.g., meeting data and/or organizational data) in association with AI technology enables an efficient and effective management of a live meeting. In addition to efficiently and effectively facilitating a live meeting, computing resource utilization is reduced as less resources may be needed to identify answers or information in association with an inquiry posed during a meeting. Further, as a result of accurately prioritizing flow of a meeting and accurately identifying responses to inquiries, unnecessary computing resource utilization associated with computers that may otherwise be used to compensate for errors or incomplete work may be minimized, thereby resulting in reduced usage of disk space, I/O operations, CPU and memory usage, power consumption, among other things.

### BRIEF DESCRIPTION OF THE DRAWINGS

The present systems and methods for facilitating management of meetings are described in detail below with reference to the attached drawing figures, wherein:

FIG. 1 provides an example network environment, in accordance with some embodiments of the present disclosure;

FIG. 2 illustrates an example implementation for facilitating management of live meetings, in accordance with some embodiments of the present disclosure;

FIG. 3 provides an example flow for managing meetings, in accordance with some embodiments of the present disclosure;

FIG. 4 provides an example flow for managing meetings, in accordance with some embodiments of the present disclosure;

FIG. 5 provides an example method for performing meeting management, in accordance with some embodiments of the present disclosure;

FIG. 6 provides an example method for performing meeting management, in accordance with some embodiments of the present disclosure;

FIG. 7 provides an example method for performing meeting management, in accordance with some embodiments of the present disclosure;

FIG. 8A is a block diagram of an example generative language model system suitable for use in implementing at least some embodiments of the present disclosure;

FIG. 8B is a block diagram of an example generative language model that includes a transformer encoder-decoder suitable for use in implementing at least some embodiments of the present disclosure;

FIG. 8C is a block diagram of an example generative language model that includes a decoder-only transformer architecture suitable for use in implementing at least some embodiments of the present disclosure;

FIG. 9 is a block diagram of an example computing device suitable for use in implementing at least some embodiments of the present disclosure; and

FIG. 10 is a block diagram of an example data center suitable for use in implementing at least some embodiments of the present disclosure.

### DETAILED DESCRIPTION

Systems and methods are disclosed related to facilitating management of live meetings, such as scrum meetings. In particular, embodiments are generally directed to automatically managing inquiry responses and/or meeting orchestration. In this way, identifying and/or responding to inquiries posed during a meeting may be performed in an automated manner. For example, as a meeting participant has an inquiry or question, a response to such an inquiry may be generated and provided in real time to address the question. As such, in accordance with an inquiry by a meeting participant, an inquiry response may be identified and provided to the meeting participant(s) in an efficient and effective manner.

Additionally or alternatively, embodiments described herein facilitate automated management of meeting orchestration. Meeting orchestration generally refers to planning, organizing, and managing aspects of a meeting to facilitate a productive meeting. In this way, in accordance with initiating a meeting, the meeting may be managed to progress or flow in a particular manner, thereby facilitating an efficient and effective meeting. For example, the flow or coordination of a live meeting may be managed in an automated manner such that directives or prompts may be provided to meeting participants, for instance, to request status updates in a prioritized manner. Advantageously, and in accordance with embodiments described herein, the meeting may be managed, for example, in association with inquiry responses and meeting orchestration, in an automated manner, resulting in a timely and effective meeting.

In operation, at a high level, meeting data may be initially obtained. Meeting data generally refers to any data associated with a meeting(s). A meeting may refer to a gathering of individuals and/or AI agents that may discuss, plan, or make decisions on specific topics or issues. A meeting may take place in various formats, such as in person, via video conferencing, over phones, etc. In some cases, a meeting may be a scrum meeting. In some examples, meeting data may represent data associated with a live meeting, such a meeting occurring in real time via a live online meeting platform. Live meeting data may include a meeting audio, a meeting transcript, meeting participants, meeting topic or documents associated with a live meeting (e.g., agenda, etc.).

In cases in which live meeting data is in the form of a meeting audio (e.g., a recorded sound or voice communication including spoken language by a meeting participant(s)), a meeting audio may be converted to a transcript. In this way, speech recognition technology may be used to transcribe the meeting content. In embodiments, generation of an audio transcription during a live meeting may occur as the meeting is happening. In this way, during the meeting, the audio may be captured and processed to enhance audio clarity. A machine learning model may be used to automatically convert spoken words from the audio into written text. Live meeting data may be obtained at any time. In some cases, live meeting data is obtained in real time as the meeting occurs. In other cases, live meeting data is obtained in a periodic manner. In this regard, transcribed text may be periodically obtained as input (e.g., during the live meeting).

Additionally or alternatively, meeting data may represent data associated with a prior meeting. A prior meeting generally refers to a meeting that occurred prior to a live meeting. In some cases, a prior meeting may have taken place via an online or virtual meeting platform. Prior meeting data may include a meeting audio, a meeting transcript, meeting participants, meeting topic or documents associated with the prior meeting (e.g., agenda, etc.). Prior meeting data may be obtained at any time. In some cases, prior meeting data is obtained upon completion of the prior meeting. In other cases, prior meeting data may be obtained in accordance with initiating or beginning a live meeting. For example, at the beginning of a live meeting, prior meeting data may be obtained in association with one or more prior meetings. In yet other cases, prior meeting data may be obtained in a periodic manner.

Prior meeting data may be obtained in association with any number of prior meetings. In some cases, prior meeting data is obtained in association with prior meetings that are related to the live meeting. A prior meeting may be identified as related to a live meeting in any number of ways. As one example, a prior meeting may be related to a live meeting based on a common meeting participant, a set of common meeting participants, a common schedule or timing for the meetings, a common topic for the meetings, a common team associated with the meetings, etc.

In accordance with initiating or conducting a live meeting, management events may be identified. A management event generally refers to an occurrence that triggers or initiates generation of a meeting insight that provides information in relation to the meeting. Generally, a management event may include any action, milestone, realization, etc. that occurs during a live meeting. In some embodiments, a management event is in the form of an inquiry event that triggers or initiates generation of an inquiry response for an inquiry. One example of an inquiry event may reception or obtaining of an inquiry, such as an inquiry input or posed by a meeting participant. In some cases, an inquiry may be provided by a meeting participant via a text box or input of a user interface. In other cases, an inquiry may be provided via verbal input during the live meeting. In such a case, the inquiry may be identified via monitoring or analyzing a live audio transcript.

Additionally or alternatively, in embodiments, a management event may be an orchestration event that triggers or initiates generation of an orchestration directive to facilitate management of a meeting. One example of an orchestration event is completion of a meeting segment or task, such as a participant update. By way of example only, upon discussing a particular meeting participant's tasks, such a completion may be identified as an orchestration event. Another example of an orchestration event may be initiation of a meeting.

In accordance with identifying a management event, contextual data relevant or related to the management event may be identified. In cases in which an inquiry event occurs (e.g., an inquiry is obtained), contextual data may be identified relevant to the inquiry. In this way, an inquiry may be used to identify contextual data relevant thereto. In some cases, meeting data may be accessed to identify contextual data. As described, meeting data may include live meeting data and/or prior meeting data. In this regard, live meeting data and/or prior meeting data may be accessed to identify data relevant to the inquiry. In some cases, a basic search may be performed in association with live meeting data and/or prior meeting data, for example to search a transcript(s) in association with keywords in an inquiry or a participant's name. In other cases, a retrieval phase or portion of Retrieval-Augmented Generation (RAG) may be performed to search for contextual data. In this way, a retrieval model, such as a vector-based similarity search, may be used to identify portions of the transcript semantically similar to the inquiry.

In addition to or in the alternative to accessing meeting data to identify contextual data, other data may be accessed or analyzed to identify contextual data relevant to an inquiry. As one example, organizational data may be accessed to identify contextual data relevant to a query. Organizational data may include any data associated with an organization or a portion thereof. For example, organizational data may include data created by a team or meeting participant. As such, based on an inquiry, organizational data may be accessed or searched to identify or retrieve data relevant to the inquiry. In some cases, a basic search may be performed, for example to search organizational data in association with keywords in a query. In other cases, RAG may be performed to search for contextual data. In this way, a retrieval model, such as a vector-based similarity search, may be used to identify portions of the organizational data semantically similar to the query.

In accordance with identifying an orchestration event, contextual data relevant or related to the orchestration event may be identified. In this way, various data may be accessed to identify contextual data relevant to management of a meeting. In some cases, meeting data may be accessed to identify contextual data. As described, meeting data may include live meeting data and/or prior meeting data. In this regard, live meeting data and/or prior meeting data may be accessed to identify data relevant to the orchestration event. In some cases, a basic search may be performed, for example to search a transcript in association with keywords associated with an orchestration event or a participant's name. In other cases, RAG may be performed to search for contextual data. In this way, a retrieval model, such as a vector-based similarity search, may be used to identify portions of the transcript semantically similar to the query.

In addition or alternatively to accessing meeting data to identify contextual data, other data may be accessed or analyzed to identify contextual data relevant to an orchestration event. As one example, organizational data may be accessed to identify contextual data relevant to an orchestration event. As such, based on an orchestration event, organizational data may be accessed or searched to identify or retrieve data relevant to the orchestration event. In some cases, a basic search may be performed, for example to search organizational data in association with keywords. In other cases, RAG may be performed to search for contextual data. In this way, a retrieval model, such as a vector-based similarity search, may be used to identify portions of the organizational data semantically similar to the meeting management event.

To generate a meeting insight, such as an inquiry response and/or orchestration directive, a prompt may be generated. In some cases, a prompt may be selected from among a set of predefined prompts. By way of example only, a prompt that is relevant to an inquiry event or an orchestration event may be selected for inputting into a machine learning model, such as an LLM. In other cases, a prompt may be generated. In generating a prompt for an inquiry response, the inquiry may be included in the prompt along with an instruction to generate an inquiry response. In addition, the identified contextual data may also be included or appended to the prompt for use in generating an inquiry response relevant to the inquiry. In generating a prompt for an orchestration directive, orchestration data (e.g., an indication of a detected event, and data associated therewith) may be included in the prompt along with an instruction to generate an orchestration directive. Further, the identified contextual data may also be included or appended to the prompt for use in generating an orchestration directive.

The prompt may be provided as input into a machine learning model, such as an LLM, VLM, MMLM, etc. which may provide as output, a meeting insight response. In some cases, a meeting insight may be an inquiry response that provides information related to or relevant to an inquiry. In other cases, a meeting insight may be an orchestration directive that provides a request, instruction, or prompt to manage the meeting or proceed in a certain way (e.g., to prompt a next meeting participant to provide a status or summary update). As can be appreciated, the meeting insight may be provided or presented via display to meeting participants via a user interface in any of a number of ways. For instance, a user interface may provide or present a meeting insight(s) using a multi-modal approach via speech, text, sounds, and/or visual elements.

Advantageously, performing automated meeting management using various contextual data (e.g., meeting data and/or organizational data) in association with AI technology enables an efficient and effective management of a live meeting. In addition to efficiently and effectively facilitating a live meeting, computing resource utilization is reduced as less resources may be needed to identify answers or information in association with an inquiry posed during a meeting. Further, as a result of accurately prioritizing flow of a meeting and accurately identifying responses to inquiries, unnecessary computing resource utilization associated with computers that may otherwise be used to compensate for errors or incomplete work may be reduced or resolved, thereby resulting in reduced usage of disk space, I/O operations, CPU and memory usage, power consumption, among other things.

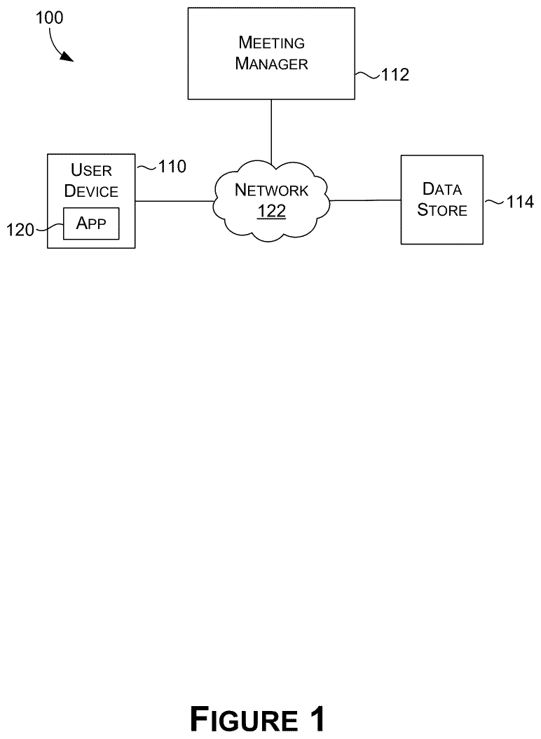

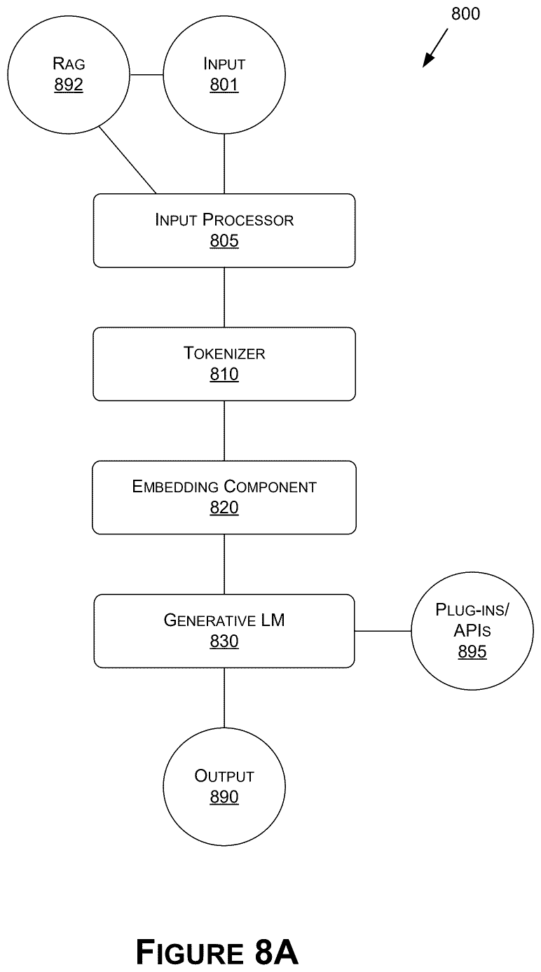

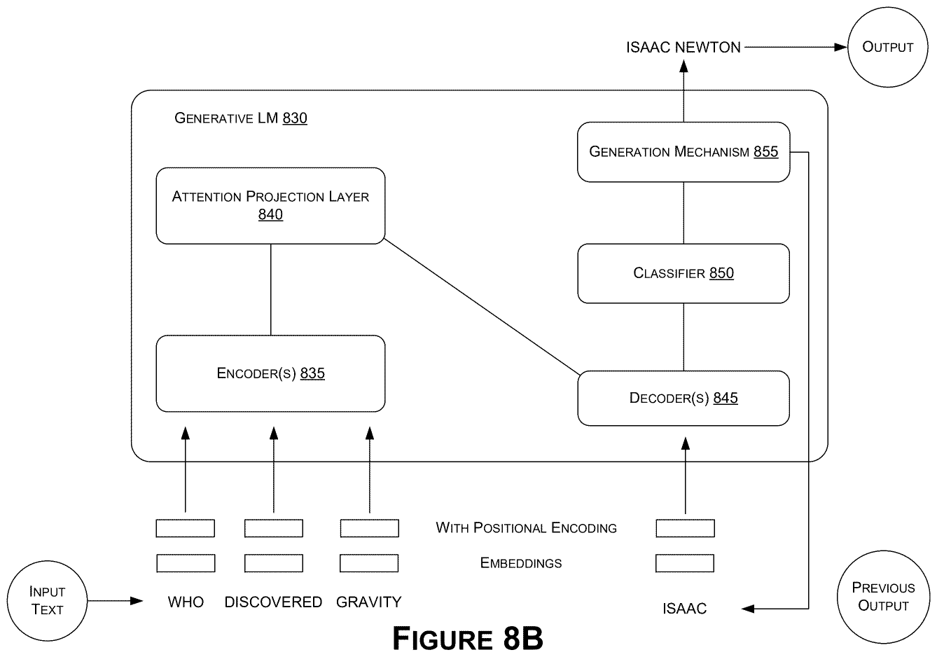

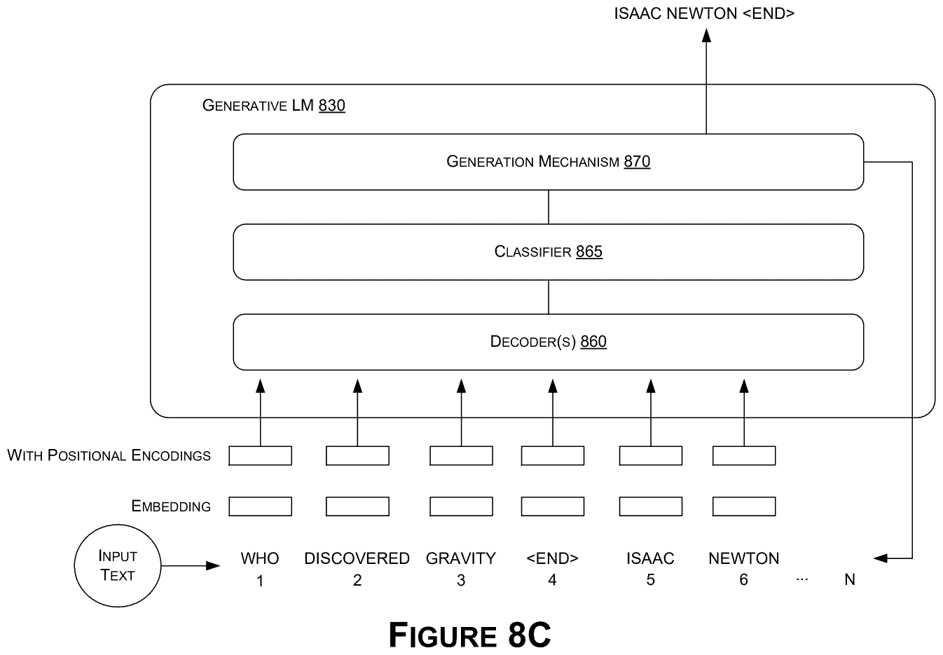

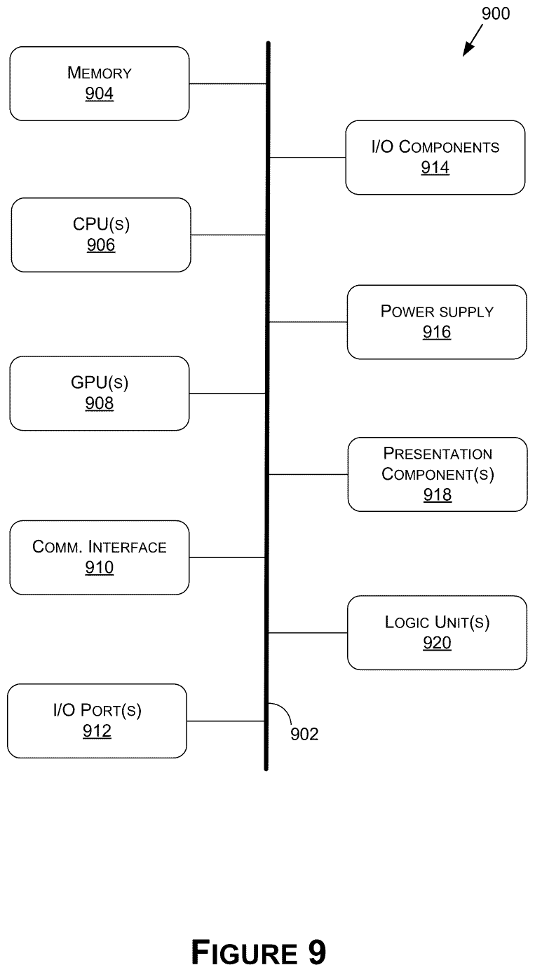

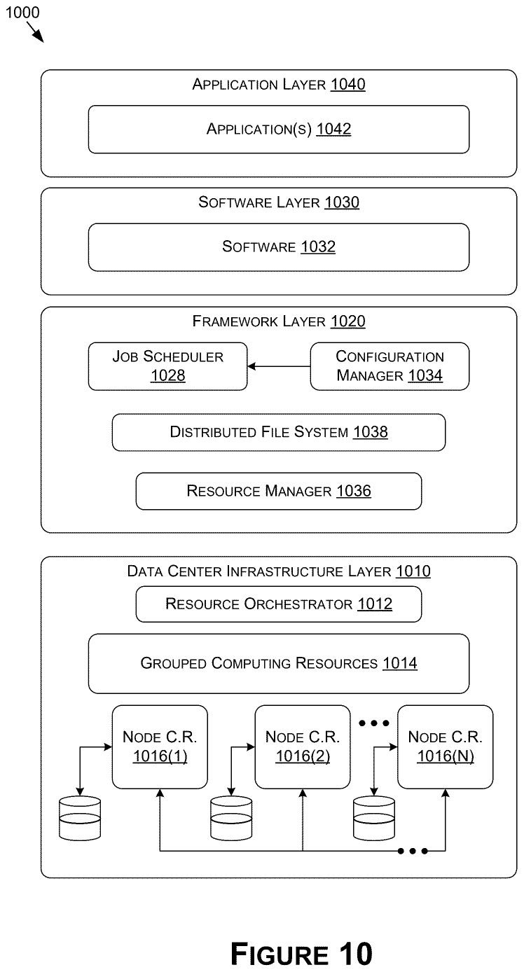

With reference to FIG. 1, FIG. 1 is an example network environment, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 8A-8C), one or more computing devices or components thereof (e.g., as described in FIG. 9), and/or one or more data centers or components thereof (e.g., as described in FIG. 10).

With continued reference to FIG. 1, a block diagram of an exemplary network environment 100 suitable for use in implementing embodiments described herein is shown. Generally, the system 100 illustrates an environment suitable for facilitating meeting management. Among other things, embodiments described herein effectively and efficiently manage meetings, such as scrum meetings, to address inquiries posed by meeting participants and facilitate the flow of the meeting. In accordance with embodiments described herein, AI technology, such as LLMs, VLMs, MMLMs, etc., may be used to perform aspects of the meeting management in an automated manner. For example, an LLM may facilitate generation of a response to an inquiry posed in a live meeting. As another example, an LLM may facilitate orchestration of the flow of a live meeting.

In operation, contextual data relevant to a detected management event, such as an inquiry event or an orchestration event, may be identified. Such contextual data may be in the form of live meeting data, prior meeting data, and/or organizational data. In accordance with identifying contextual data relevant to a management event, the contextual data (e.g., live meeting data, prior meeting data, and/or organizational data) may be used generate a meeting insight. In this regard, a prompt that includes the contextual data may be input to an LLM and, based on the input, a meeting insight may be automatically generated and provided to a meeting participant(s) of a live meeting. The meeting insight may be in the form of an inquiry response or an orchestration directive, for example, depending on the detected management event.

The network environment 100 includes a user device 110, a meeting manager 112, and a data store 114. The user device 110, the meeting manager 112, and the data store 114, can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device may be in communication with the meeting manager 112 via a mobile network or the Internet, and the meeting manager 112 may be in communication with data store 114 via a local area network. Further, although the environment 100 is illustrated with a network, one or more of the components may directly communicate with one another, for example, via HDMI (high-definition multimedia interface) and DVI (digital visual interface). Alternatively, one or more components may be integrated with one another. For example, at least a portion of the meeting manager 112 and/or data store 114 may be integrated with the user device 110. For instance, a portion of the meeting manager 112 may be integrated with a server in communication with a user device 110, while another portion of the meeting manager 112 may be integrated with the user device 110.

The user device 110 can be any kind of computing device capable of facilitating efficient and effective meeting management. For example, in an embodiment, the user device 110 can be a computing device such as computing device 900, as described above with reference to FIG. 9. In embodiments, the user device 110 can be a personal computer (PC), a laptop computer, a workstation, a mobile computing device, a personal digital assistant (PDA), a cell phone, or the like.

The user device 110 may include one or more processors and one or more computer-readable media. The computer-readable media may include computer-readable instructions executable by the one or more processors. The instructions may be embodied by one or more applications, such as application 120 shown in FIG. 1. The application(s) may generally be any application capable of facilitating management of meetings. For example, application 120 may be or include a virtual meeting platform. In some implementations, the application(s) comprises a web application, which can run in a web browser, and could be hosted at least partially server-side (e.g., via meeting manager 112). In addition, or instead, the application(s) may comprise a dedicated application. In some cases, the application is integrated into the operating system (e.g., as a service). As one specific example application, application 120 may be a virtual meeting platform or tool, or a portion thereof, that enables hosting or participating in virtual meetings (e.g., enables real-time communication). Application 120 may be accessed via a mobile application, a web application, or the like.

User device 110 may be a client device on a client-side of operating environment 100, while meeting manager 112 may be on a server-side of operating environment 100. Meeting manager 112 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted there is no requirement for each implementation that any combination of user device 110 and meeting manager 112 to remain as separate entities.

In an embodiment, the user device 110 is separate and distinct from the meeting manager 112 and the data store 114 illustrated in FIG. 1. In another embodiment, the user device 110 is integrated with one or more illustrated components. For instance, the user device 110 may incorporate functionality described in relation to the meeting manager 112. For clarity of explanation, embodiments are described herein in which the user device 110, the meeting manager 112, and the data store 114 are separate, while understanding that this may not be the case in various configurations contemplated.

As described, a user device, such as user device 110, may facilitate automated meeting management. In particular, the user device 110 may facilitate the meeting manager 112 obtaining data (e.g., inquiry data and/or orchestration data) and, in response, provide a meeting insight including an inquiry response and/or orchestration directive. A user device 110, as described herein, may be operated by an individual or set of individuals that participate in a meeting and/or desire to view meeting insights in association therewith. In some cases, the user device 110 may be operated by a meeting participant or meeting manager.

In some cases, meeting management may be initiated at the user device 110. In this regard, a user may provide or select an inquiry to initiate generation of an inquiry response. As another example, a user may discuss a particular portion or segment of a meeting and, upon concluding the discussion, generation of an orchestration directive may be initiated.

In embodiments, initiation of meeting management may occur via an application 120 operating on the user device 110. In this regard, the user device 110, via an application 120, might allow a user to input, select, or otherwise provide an inquiry or other. The application 120 may facilitate the inputting of data in a verbal form, a textual input form, a document form, an image form, etc. Such data may be input at the user device 110 in any manner. For instance, upon initiating or beginning a virtual meeting, a user may be presented with, or navigate to, an input tool to input or select an inquiry for which a response is derived. As another example, a user may provide an indication via a user interface of completion of a portion or segment of the meeting.

In accordance with generating a meeting insight, such as an inquiry response and/or an orchestration directive, a representation of such a meeting insight may be presented to the user via the application 120 operating on the user device 110. In this way, any meeting insight identified may be displayed to an individual or meeting participant desiring to view meeting insights. In some cases, a meeting insight(s) may be presented to all the meeting participants. In other cases, a meeting insight(s) may be presented to a particular meeting participant(s). For instance, in some cases, assume an inquiry is posed by a particular meeting participant. In such a case, a generated inquiry response may be presented only to the particular meeting participant that posed the inquiry. As another example, a generated orchestration directive may be presented only to a meeting participant designated as a meeting master, or other manager or leader of the meeting.

The user device 110 can communicate with the meeting manager 112 to provide input data (e.g., an inquiry) and/or obtain a representation of a meeting insight(s). In embodiments, for example, a user may utilize the user device 110 to provide an inquiry via the network 122. For instance, in some embodiments, the network 122 might be the Internet, and the user device 110 interacts with the meeting manager 112 to provide an inquiry for use in generating an inquiry response. In other embodiments, for example, the network 122 might be an enterprise network associated with an organization. It should be apparent to those having skill in the relevant arts that any number of other implementation scenarios may be possible as well.

With continued reference to FIG. 1, the meeting manager 112 can be implemented as server systems, program modules, virtual machines, components of a server or servers, networks, and the like. At a high level, the meeting manager 112 manages facilitation of meetings in an efficient and effective manner. In particular, in association with obtaining an inquiry, the meeting manager 112 may facilitate generation of an inquiry response to provide to a meeting participant or set of meeting participants. In this way, as opposed to various meeting participants searching for an answer to the presented inquiry, a response may be efficiently provided that addresses the question, for example, using data from the live meeting, data from a prior meeting(s), and/or organizational data. Additionally or alternatively, the meeting manager 112 may facilitate orchestration of the meeting flow. In this way, the meeting manager 112 may identify orchestration events that indicate to generate a directive for managing the meeting. In accordance with the event, a prompt or directive may be provided to guide the meeting in an efficient and progressive manner. For instance, following a discussion of a particular prioritized task, a prompt to move to a discussion for a subsequently prioritized task may be provided to the meeting participants to advance the discussion in a meaningful and organized manner.

Further, embodiments described herein perform meeting management in an efficient manner. For example, AI technology, such as an LLM(s), is used to facilitate efficient and comprehensive meeting management. In particular, various technology may be used to identify relevant contextual data to analyze as well as to generating meeting insights based on the contextual data.

In operation, in one example, a management event is detected at the meeting manager 112. For example, in some cases, an inquiry may be obtained or identified. As another example, an orchestration event indicating the beginning of a meeting or a completion of a meeting segment may be identified. The meeting manager 112 may then identify contextual data relevant to the particular management event. For example, for an inquiry, the meeting manager 112 may identify live meeting data, prior meeting data, and/or organizational data relevant to the inquiry to facilitate generation of a response to the inquiry. As another example, for an orchestration event, the meeting manager 112 may identify live meeting data, prior meeting data, and/or organizational data relevant to the orchestration event to facilitate generation of an orchestration directive to facilitate flow of the meeting. A prompt may be generated that includes the identified contextual data, which may then be provided as input (e.g., to an LLM) to initiate generation of a meeting insight. Representations of meeting insights, such as inquiry responses and/or orchestration directives, may be provided for display, for example, to a user (e.g., meeting participant) via a user device, such as user device 110.

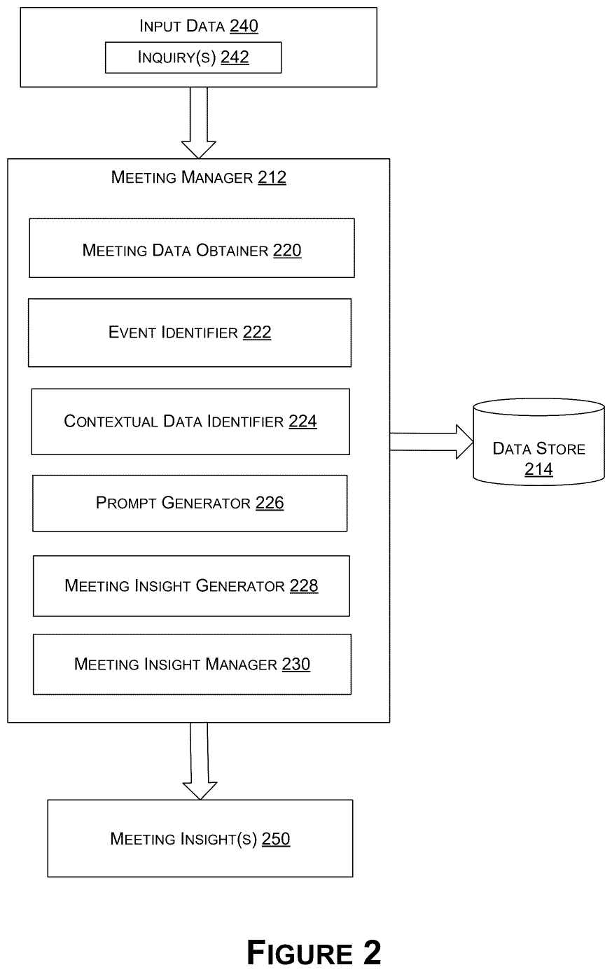

Turning now to FIG. 2, FIG. 2 illustrates an example implementation for facilitating management of meetings via meeting manager 212. In operation, the meeting manager 212 is generally configured to manage inquiry responses and/or meeting orchestration. In particular, meeting manager 212 may manage identifying and/or responding to inquiries posed during a meeting in an automated manner. In this way, in accordance with an inquiry by a meeting participant, an inquiry response may be identified and provided to the meeting participant(s) in an efficient and effective manner. Generally, various data may be searched to identify an inquiry response, such as, for example, live meeting data, prior meeting data, and/or organizational data. Additionally or alternatively, meeting manager 212 may manage meeting orchestration. Meeting orchestration generally refers to planning, organizing, and managing aspects of a meeting to facilitate a productive meeting. In particular, the meeting manager 212 facilitates managing meeting orchestration in an automated manner. In this way, in accordance with initiating a meeting, the meeting may be managed to progress or flow in a particular manner, thereby facilitating an efficient and effective meeting. Advantageously, and in accordance with embodiments described herein, the meeting may be managed, for example, in association with inquiry responses and meeting orchestration, in an automated manner, resulting in a timely and effective meeting.

The meeting manager 212 can communicate with the data store 214. The data store 214 is configured to store various types of information accessible by the meeting manager 212, or other server or component. In embodiments, meeting manager 212 and user device(s) (such as user device 110 of FIG. 1) can provide data to the data store 214 for storage, which may be retrieved or referenced by any such component. As such, the data store 214 may store various types of data, such as live meeting data, prior meeting data, organizational data, inquiry responses, orchestration directives, or combinations thereof or representations thereof.

In embodiments, the meeting manager 212 includes a meeting data obtainer 220, an event identifier 222, a contextual data identifier 224, a prompt generator 226, a meeting insight generator 228, and a meeting insight manager 230. According to embodiments described herein, the meeting manager 212 can include any number of other components not illustrated. In some embodiments, one or more of the illustrated components 220, 222, 224, 226, 228, and 230 can be integrated into a single component or can be divided into a number of different components. Components 220, 222, 224, 226, 228, and 230 can be implemented on any number of machines and can be integrated, as desired, with any number of other functionalities or services.

At a high level, the meeting manager 212 obtains data associated with a meeting(s), such as input data 240 (e.g., an inquiry), and generates a meeting insight(s) 250 that may be provided to one or more participants or attendees of a live meeting (e.g., operated via a meeting platform). As described, a meeting insight generally refers to an insight or information related to a meeting, such as a scrum meeting. Meeting insights may be in any of a number of formats that provide information or data related to a meeting. In some cases, meeting insights may be in the form of an inquiry response or answer to a question posed by a meeting attendee. In other cases, meeting insights might be in the form of an orchestration directive or an instruction related to managing a meeting. In this way, the meeting insight may facilitate the flow of a meeting, resulting in a more efficient and effective meeting.

Turning to the meeting data obtainer 220, the meeting data obtainer 220 is generally configured to obtain meeting data. Meeting data generally refers to any data associated with a meeting(s). A meeting generally refers to a gathering of individuals that may discuss, plan, or make decisions on specific topics or issues. A meeting may take place in various formats, such as in person, via video conferencing or virtual meeting platform, over phones, etc. In some cases, a meeting may be a scrum meeting.

In some cases, meeting data may represent data associated with a live meeting, also referred to as live meeting data. A live meeting generally refers to a meeting that occurs in real-time or that is current or ongoing. In some cases, a live meeting may take place via a live online platform. Live meeting data may include a meeting audio, a meeting transcript, an indication of meeting participants, a meeting topic or documents associated with a live meeting (e.g., agenda, etc.).

As described, in some cases, live meeting data is obtained in the form of a meeting audio. A meeting audio generally refers to a recorded sound or voice communication that occurs during a meeting in real time. Meeting audio may include spoken language by participants, including discussions, presentations, questions and answers. In such cases, a meeting audio may be converted to a transcript. In this way, speech recognition technology may be used to transcribe the meeting audio into text. For example, in cases in which meeting data is obtained in the form of meeting audio, a meeting transcript may be generated via speech recognition technology. In embodiments, generation of an audio transcript during a live meeting may occur as the meeting is happening. In this way, during the meeting, the audio may be captured and processed to enhance clarity. A machine learning model may be used to automatically convert spoken words from the audio into written text. In embodiments, AI technology, such as an LLM, may be used to enhance or refine a transcription once it is in text form.

Live meeting data may be obtained at any time. In some cases, live meeting data is obtained in real time, that is, as the meeting occurs. In other cases, live meeting data is obtained in a periodic manner. In this regard, live meeting data, such as transcribed text, may be periodically obtained as input (e.g., during the live meeting). Live meeting data may be obtained by any number or type of devices, components, or systems. As one example, live meeting data may be obtained by one or more user devices (e.g., meeting participant device). As another example, live meeting data may be obtained by a platform or system hosting a live meeting (e.g., a virtual meeting platform). The obtained live meeting data, such as an audio transcript, may be stored, for example, via data store 214, for subsequent use by the meeting manager 212.

Additionally or alternatively, meeting data may represent data associated with a prior meeting, also referred to as prior meeting data. A prior meeting generally refers to a meeting that occurred prior to a live meeting. In some cases, a prior meeting may have taken place via an online platform (e.g., virtual meeting platform). Prior meeting data may include a meeting audio, a meeting transcript, meeting notes, an indication of meeting participants, a meeting topic or documents associated with the prior meeting (e.g., agenda, etc.). In some cases, meeting notes may be collected or obtained in a particular format such that the notes are efficient to analyze.

Prior meeting data may be obtained at any time. In some cases, prior meeting data is obtained upon completion of the prior meeting. For example, a meeting audio may be converted to a text transcript following a meeting and obtained via the meeting data obtainer 220. In other cases, prior meeting data may be obtained in accordance with initiating or beginning a live meeting. For example, at the beginning of a live meeting, prior meeting data may be obtained in association with one or more prior meetings. In yet other cases, prior meeting data may be obtained in a periodic manner. In this regard, prior meeting data may be periodically obtained as input. Prior meeting data may be obtained by any number or type of devices, components, or systems. As one example, prior meeting data may be obtained by one or more user devices (e.g., meeting participant devices). As another example, prior meeting data may be obtained by a platform or system that hosted the prior meeting (e.g., virtual meeting platform). The obtained prior meeting data may be stored, for example, via data store 214, for subsequent use by the meeting manager 212.

As described, prior meeting data may be obtained in association with any number of prior meetings. In some cases, prior meeting data is obtained in association with prior meetings that are related to a live meeting. A prior meeting may be identified as related to a live meeting in any number of ways. As one example, a prior meeting may be related to a live meeting based on a common meeting participant, a set of common meeting participants, a common schedule or timing for the meetings, a common topic for the meetings, a common team associated with the meetings, etc.

The event identifier 222 is generally configured to identify management events. A management event generally refers to an event or occurrence that indicates or triggers management of the meeting, such as, for example, generation of a meeting insight. A management event may include any action, milestone, response, interaction, selection, input, realization, etc. that occurs during a live meeting. In some embodiments, a management events includes an inquiry event. An inquiry event refers to an event that triggers or initiates generation of an inquiry response. One example of an inquiry event may be obtaining input data in the form of an inquiry, such as inquiry 242 of input data 240. In some cases, an inquiry, question, or query may be input or provided via a text box or input of a user interface. As such, a meeting participant may use a text box to input an inquiry. In this way, the event identifier 222 may monitor for text input to identify inquiry events. In other cases, an inquiry may be provided via verbal input during a live meeting. In such a case, an inquiry may be identified via monitoring or analyzing a live audio or text transcript generated therefrom. In this regard, the event identifier 222 may monitor audio for verbal inquiries or monitor a transcript for inquiries.

Additionally or alternatively, in embodiments, management events include orchestration events. An orchestration event generally refers to an event that triggers or initiates generation of an orchestration directive, such as an instruction or prompt. One example of an orchestration event may include initiation of a meeting. For example, in accordance with initiating a meeting session via a virtual meeting platform, an orchestration event may be detected. Another example of an orchestration event may be completion of a meeting segment or task, such as a meeting participant update. In embodiments, the event identifier 222 may monitor live meeting data (e.g., in audio format and/or text format) to identify an orchestration event. For instance, a live audio transcript may be monitored to identify any actions or milestones attained during the live meeting. By way of example only, upon discussing a meeting participant's task(s), such a completion of a meeting segment may be recognized as an orchestration event.

In accordance with identifying a management event, such as an inquiry event and/or an orchestration event, the contextual data identifier 224 is generally configured to identify contextual data relevant or related to the management event. Contextual data may be any data that may facilitate generation of a meeting insight in association with the management event. For example, as described, contextual data may be any portion of live meeting data, prior meeting data, and/or organizational data for use in generating a meeting insight relevant to a management event.

In cases in which an inquiry event is detected, such as by obtaining or receiving an inquiry, the contextual data identifier 224 may identify contextual data relevant to the inquiry for use in generating an inquiry response. In this way, an inquiry may be used to identify contextual data relevant thereto. In some cases, meeting data may be accessed to identify contextual data. As described, meeting data may include live meeting data and/or prior meeting data. In this regard, live meeting data and/or prior meeting data may be accessed to identify data relevant to the inquiry. As one example, based on an inquiry, live meeting data may be accessed or searched to identify or retrieve data relevant to the inquiry. Alternatively or additionally, based on an inquiry, prior meeting data may be accessed or searched to identify or retrieve data relevant to the inquiry. In some cases, a basic search may be performed, for example to search a transcript (e.g., live meeting transcript or prior meeting transcript) in association with keywords in an inquiry or a meeting participant's name. In other cases, a retrieval phase or portion of Retrieval-Augmented Generation (RAG) may be performed to search for contextual data. In this way, a retrieval model, such as a vector-based similarity search, may be used to identify portions of meeting data (e.g., a transcript) semantically similar to the inquiry.

Additionally or alternatively to accessing meeting data to identify contextual data, other data may be accessed or analyzed to identify contextual data relevant to an inquiry. As one example, organizational data may be accessed to identify contextual data relevant to an inquiry. Organizational data may include any data associated with an organization or a portion thereof. For example organizational data may include data associated with or generated within an organization. Organizational data may include team data or participant data, such as communications sent from or sent to a team member or meeting participant, a document prepared by a team member or meeting participant, etc. Organizational data may also include data generated or used outside of the team or meeting participants (e.g., work created by a different team). As such, based on an inquiry posed by a meeting participant, organizational data (e.g., associated with the team or the meeting participant) may be accessed and searched to identify or retrieve contextual data relevant to the inquiry. In some cases, a basic search may be performed, for example to search organizational data in association with keywords in an inquiry. In other cases, a retrieval phase or portion of RAG may be performed to search for contextual data. In this way, a retrieval model, such as a vector-based similarity search, may be used to identify portions of organization data semantically similar to the inquiry.

In accordance with identifying an orchestration event, the contextual data identifier 224 is generally configured to identify contextual data relevant or related to the orchestration event for use in generating an orchestration directive. In this way, an indication of an orchestration event may be used to identify contextual data relevant thereto. In some cases, meeting data may be accessed to identify contextual data. As described, meeting data may include live meeting data and/or prior meeting data. In this regard, live meeting data and/or prior meeting data may be accessed to identify data relevant to the orchestration event. As one example, based on an orchestration event (e.g., initiation of the live meeting, completion of a portion or segment of the live meeting, etc.), live meeting data may be accessed or searched to identify or retrieve data relevant to the orchestration event. Alternatively or additionally, based on an orchestration event, prior meeting data may be accessed or searched to identify or retrieve data relevant to the orchestration event. In some cases, a basic search may be performed, for example to search a transcript (e.g., live meeting transcript or prior meeting transcript) in association with keywords associated with an orchestration event or a meeting participant's name. In other cases, a retrieval phase or portion of RAG may be performed to search for contextual data. In this way, a retrieval model, such as a vector-based similarity search, may be used to identify portions of meeting data (e.g., a transcript) semantically similar to aspects of an orchestration event.

In addition to or in the alternative to accessing meeting data to identify contextual data, other data may be accessed or analyzed to identify contextual data relevant to an orchestration event. As one example, organizational data may be accessed to identify contextual data relevant to an orchestration event. As such, based on an orchestration event, organizational data may be accessed or searched to identify or retrieve data relevant to the orchestration event. In some cases, a basic search may be performed, for example to search organizational data in association with keywords associated with an orchestration event. In other cases, RAG may be performed to search for contextual data. In this way, a retrieval model, such as a vector-based similarity search, may be used to identify portions of the organizational data semantically similar to an orchestration event.

In some cases, the contextual data identifier 224 may identify contextual data in a sequential manner. As one example, the contextual data identifier 224 may initially search for contextual data in association with a live meeting. Thereafter, the contextual data identifier 224 may search for data in association with a prior meeting or set of prior meetings. Subsequently, organizational data may be searched for relevant contextual data. In some cases, a subsequent search of a type of data may be based on whether contextual data is identified in a current search. For example, in cases in which searching a live meeting results in identification of contextual data, further searches of prior meetings and/or organizational data may not be performed.

The prompt generator 226 is generally configured to generate a prompt that may be used to initiate generation of a meeting insight(s), such as an inquiry response and/or an orchestration directive. A prompt generally refers to an input, such as an input text, that can be provided to a meeting insight generator 228, such as an LLM, LVM, and/or MLLM, to generate an output in the form of a meeting insight(s). In embodiments, a prompt can include data, such as text and/or images, or an indication or reference thereto to influence an AI model (e.g., an LLM) to generate meeting insights having a desired content and/or structure. A prompt typically includes text given to an AI model to be completed. In this regard, a prompt generally includes instructions and, in some cases, identified relevant contextual data to use in performing the analysis. Additionally or alternatively, the prompt may include images, or other non-text data, to influence an AI model, such as an LVM and/or MLLM, to generate an output having desired content and structure.

In accordance with embodiments described herein, a prompt may include or reference various data. By way of example only, a prompt may include an instruction or request, inquiry data, orchestration data, and/or contextual data, or references thereto, to be analyzed. An instruction generally refers to a request for generating a meeting insight(s) (e.g., an inquiry response and/or orchestration directive) for example, in accordance with contextual data. The particular data included in a prompt may depend on a type of meeting insight to generate, such as an inquiry response or an orchestration directive.

In some cases, a prompt may be composed to request generation of an inquiry response, which may also be referred to herein as an inquiry prompt. In this regard, an inquiry prompt may include a request to generate an inquiry response based on inquiry data and corresponding relevant contextual data (e.g., included in the prompt or referenced in the prompt). As such, the inquiry prompt may include the inquiry, or a representation thereof (e.g., a portion of the inquiry) such that an inquiry response may be generated. In some cases, an instruction to generate an inquiry response may include an indication of the inquiry.

Further, contextual data, or an indication or representation thereof, relevant to the inquiry may be included or referenced in the inquiry prompt to use in generating an inquiry response. For instance, contextual data identified by the contextual data identifier 224 may be included in the inquiry prompt. By way of example only, assume an inquiry posed by a meeting participant is obtained. Further, assume meeting data associated with a live meeting and/or a prior meeting(s) is searched to identify data relevant to responding to the inquiry. In such a case, the identified relevant meeting data is added as contextual data in the prompt to facilitate generation of an inquiry response. As another example, assume organizational data is searched to identify relevant data to responding to the inquiry. In such a case, the identified relevant organizational data is added as contextual data in the prompt to facilitate generating an inquiry response. In some embodiments, the prompt generator 226 may include the contextual data, or a portion thereof, in the prompt to generate an inquiry response. For example, live meeting data, prior meeting data, and/or organizational data may be included in the prompt. In other embodiments, the prompt generator 226 may include a representation or indication of the contextual data. In this way, the indications of the data may be included in the prompt and, as such, the meeting insight generator 228 may obtain the data, or search for the data, in accordance with the data indications provided in the prompt.

In some cases, a prompt may be created to request generation of an orchestration directive, which may also be referred to herein as an orchestration prompt. In this regard, an orchestration prompt may include a request to generate an orchestration directive based on an orchestration event and corresponding relevant contextual data (e.g., included in the prompt or referenced in the prompt). As such, the orchestration prompt may include an indication of an orchestration event, or a representation thereof, such that an orchestration directive may be generated. For example, assume an orchestration event includes a start of the meeting. In such a case, the orchestration prompt may include an indication that the meeting has started. As another example, assume an orchestration event includes an indication that a particular meeting participant has concluded a discussion (e.g., a status update on a work task(s)). In such a case, the orchestration prompt may include an indication that a particular meeting portion or segment has concluded. In some cases, a particular instruction for generating an orchestration directive may be based on the orchestration event. For example, in cases in which a meeting initiation is identified as the orchestration event, the instruction may request identification of a highest priority task. As another example, in cases in which a discussion in relation to a prioritized task has concluded, the instruction may request identification of a next highest priority task.

An instruction for an orchestration directive provided in an orchestration prompt may include or relate to any type of orchestration directive. For example, an instruction may relate to a request for task assignment or task follow-up, agenda item prioritization, time allocation suggestions, participant engagement, meeting efficiency (e.g., request to generate smooth transition between topics), summarization (e.g., real-time meeting segment summarization or meeting summarization), etc.

Further, contextual data, or an indication or representation thereof, relevant to the orchestration event may be included or referenced in the orchestration prompt to use in generating an orchestration directive. For instance, contextual data identified by the contextual data identifier 224 may be included in the orchestration prompt. By way of example only, assume an orchestration event is identified. Further, assume meeting data associated with a live meeting and/or a prior meeting(s) is searched to identify data relevant thereto. In such a case, the identified relevant meeting data is added as contextual data in the prompt to facilitate generating an orchestration directive. In some embodiments, the prompt generator 226 may include the contextual data, or a portion thereof, in the prompt to generate an orchestration directive. For example, live meeting data, prior meeting data, and/or organizational data may be included in the prompt. In other embodiments, the prompt generator 226 may include a representation or indication of the contextual data. In this way, the indications of the data may be included in the prompt and, as such, the meeting insight generator 228 may obtain the data, or search for the data, in accordance with the data indications provided in the prompt.

As can be appreciated, in some embodiments, a prompt, such as an inquiry prompt and/or an orchestration prompt, may include additional or alternative data, such as output attributes or additional context. Output attributes generally indicate desired aspects associated with an output, such as a meeting insight(s). For example, an output attribute may indicate a target temperature to be associated with the output. A temperature refers to a hyperparameter used to control the randomness of predictions. Generally, a low temperature makes the model more confident, while a higher temperature makes the model less confident. Stated differently, a higher temperature can result in more random output, which can be considered more creative. On the other hand, a lower temperature generally results in a more deterministic and focused output. A temperature may be a default value, a value based on user input, or a determined value. As another example, an output attribute may indicate a length of output. For example, a prompt may include an instruction for a desired number of paragraphs or sentences. As another example, a prompt may include an instruction for a maximum number of characters or a target range of characters. As another example, an output attribute may indicate a format for the response (e.g., image format, text format, etc.). As another example, an output attribute may indicate a target language for generating the output. For example, the text data may be provided in one language, and an output attribute may indicate to generate the output in another language. Any other instructions indicating a desired output are contemplated within embodiments of the present technology.

Additional context may include any additional information that provides context to the request. Additional context may include a day/time, meeting attendees, meeting master, meeting presenter, etc. Any additional context may be provided to indicate or describe the live meeting, the desired meeting insight, etc.

In some embodiments, the prompt generator 226 may be configured to select particular data, such as relevant contextual data, to include in the prompt. As one example, contextual data may be selected to be under a maximum number of tokens required by a meeting insight generator, such as an LLM. For example, assume an LLM includes a 3,000-token limit. In such a case, text data totaling less than the 3,000-token limit may be selected. In this regard, prompts may have a size limit, thereby limiting the number of relevant contextual data included in the prompt. As such, in some cases, using all identified contextual data may not be possible to be used as a prompt to an LLM due to size limitations of an LLM. Hence, it is necessary to select an optimal set of contextual data for feeding to the LLM for obtaining meeting insights. Although generally described as using tokens (e.g., pieces of words, individual sets of letters within words, spaces between words, and/or other natural language symbols or characters), for input size, as can be appreciated, other input sizes may be used and may not necessarily be based on token sequence length, but other data size parameters, such as bytes, number of words, etc.

Accordingly, in embodiments, the prompt generator 226 may be configured to select data, such as contextual data, to include in a prompt to generate a meeting insight, such as an inquiry response and/or orchestration directive. To identify contextual data to include, any aspect or score may be used. For example, in some cases, a relevance data score may be generated and used to select contextual data. The score may represent an importance or value associated with the contextual data. Such a score may indicate an extent or measure of some aspect for assessing data to include in the prompt. For example, a score may indicate relevance to informativeness, diversity, and/or the like. In other cases, contextual data associated with a selected or particular data source may be selected. For instance, contextual data associated with a live meeting may be prioritized over contextual data associated with a prior meeting. Similarly, contextual data associated with a more recent prior meeting may be prioritized over contextual data associated with a less recent prior meeting.

In some cases, the prompt generator 226 may format a prompt in a particular form or data structure. One example of a data structure for an inquiry prompt is as follows:
{ Instruction to generate an inquiry response
{ Inquiry Data
{ Set of contextual data relevant to the inquiry to use for generating an inquiry response
   { Live Meeting Data relevant to the inquiry data
   { Prior Meeting Data relevant to the inquiry data
      . . .
   { Organizational Data relevant to the inquiry data

One example of a data structure for an orchestration prompt is as follows:
{ Instruction to generate an orchestration directive
{ Data related to orchestration event
{ Set of contextual data relevant to the orchestration event to use for generating an orchestration directive
   { Live Meeting Data relevant to the orchestration event
   { Prior Meeting Data relevant to the orchestration event
      . . .
   { Organizational Data relevant to the orchestration event

Any number of prompts may be generated. As one example, different prompts may be generated for different events detected (e.g., a first prompt for a first orchestration event, a second prompt for a second orchestration event, and a third prompt for a first inquiry event).

In some cases, the prompt generator 226 may use a predefined prompt(s) or prompt template to generate a prompt, such as an inquiry prompt and/or an orchestration prompt. In this regard, the prompt generator 226 may select a prompt from among a set of predefined or predetermined prompts. As one example, one or more template prompts may be pre-generated for different types of inquiry prompts.

In some cases, the predetermined prompts may include inquiry prompts. For instance, for common inquiries, corresponding inquiry prompts may be generated. As another example, one or more prompts may be pre-defined for orchestration prompts. For instance, assume a scrum meeting is generally conducted to be orchestrated in a particular order or sequence. In such a case, orchestration prompts may be generated that correspond with the sequence. For instance, a first orchestration prompt may be pre-generated in association with starting the meeting. A second orchestration prompt may be pre-generated in association with particular sequence of tasks or priorities, a particular sequence of meeting participant segments, etc.

A prompt(s) may be provided as input into the meeting insight generator 228, which may provide a meeting insight as output. As described, a meeting insight may be in any number of forms. As one example, a meeting insight may be in the form of an inquiry response. In another example, a meeting insight may be in the form of an orchestration directive (e.g., to prompt a next meeting participant to provide a status or summary update).

The meeting insight generator 228 is generally configured to generate meeting insights. In this regard, the meeting insight generator 228 analyzes data in the prompt and outputs a meeting insight. In this way, the meeting insight generator 228 may generate text, images, videos, combinations thereof, etc. In embodiments, the meeting insight generator 228 takes, as input, a prompt generated by the prompt generator 226. Based on the prompt, the meeting insight generator 228 can generate a meeting insight(s), for example, associated with contextual data, such as live meeting data, prior meeting data, and/or organizational data, in the prompt. For instance, assume a prompt includes live meeting data associated with an inquiry posed by a meeting participant, or a portion thereof. In such a case, the meeting insight generator 228 identifies or generates an inquiry response, such as in the form of text and/or images, based on the contextual data identified as being relevant to the inquiry included or referenced in the prompt.

Various types of meeting insights may be generated. For instance, in some cases, an inquiry response may be generated. In such a case, the prompt may include an inquiry and corresponding contextual data (e.g., meeting data and/or organizational data) and, in response, an inquiry response is generated. Additionally or alternatively, an orchestration directive may be generated to facilitate managing the flow of a meeting. In this regard, a prompt may include contextual data related to tasks or assignees from prior meeting notes and, in response, various types of orchestration directives may be generated. As one example, an orchestration directive related to task assignment and/or task follow-up may be generated. For instance, an orchestration directive to follow-up on a previous action item(s) may be generated, such as “Check on the last update from participant XYZ and list the Action Items which XYZ is required to provide updates on.” As another example, an orchestration directive related to meeting flow management may be generated. For instance, an orchestration directive to suggest how to prioritize agenda items may be generated, such as “Start with the requirement review as it's critical for the upcoming release planning.” Alternatively or additionally, an orchestration directive to suggest time allocations may be generated, such as “Allocate 20 minutes for the project update, focusing on milestones achieved since the last meeting.” As yet another example, an orchestration directive related to participant engagement may be generated. For instance, an orchestration directive to encourage participation may be generated, such as “Ask Team A to share their progress on the Infra process improvements.” As yet another example, an orchestration directive related to meeting efficiency may be generated. For instance, an orchestration directive for smooth transitions between topics may be generated (e.g., “After concluding the project updates, transition to the blocker issues presented by the QA team.”) or for real-time summarization (e.g., “After concluding all agenda items, pause for a quick summary of key points discussed so far.”)

The meeting insight generator 228 may be or include any number of AI models or technologies (e.g., generative AI models or technologies). In this way, to effectively and efficiently manage meetings, the meeting insight generator 228 may be, include, access, or communicate with AI technology. In some embodiments, the AI model is a Large Language Model (LLM). A language model is a statistical and probabilistic tool that determines the probability of a given sequence of words occurring in a sentence (e.g., via next sentence prediction [NSP] or minimal learning machine [MLM]). In this way, it is a tool that is trained to predict the next word in a sentence. A language model is called a large language model when it is trained on an enormous amount of data. Some examples of LLMs are OPT, FLAN-T5, BART, GOOGLE's BERT, and OpenAI's GPT-2, GPT-3, and GPT-4. For instance, GPT-3, is a large language model with 175 billion parameters trained on 570 gigabytes of text. These models have capabilities ranging from writing a simple essay to generating complex computer codes—all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities.

Additionally or alternatively, the meeting insight generator 228 may be in the form of a large vision model (LVM) that can interpret and understand visual information. A visual model may be built using a deep learning technique, such as convolutional neural networks (CNNs) and/or transformer models, which are well-suited for tasks involving image recognition, classification, segmentation, object detection, etc. At a high level, a vision model processes visual data in the form of images or videos by extracting features at various levels of abstraction to understand the content. Vision models learn to recognize patterns, shapes, textures, and other visual cues that are relevant to a task. Examples of vision models include Landing AI's LandingLens and Google's Vision Transformer (ViT).

Further, the meeting insight generator 228 may be in the form of a multimodal large language model (MLLM) that can interpret and understand visual information. An MLLM generally understands and generates text while also processing and comprehending other modalities, such as images, audio, and/or video. MLLM can associate text with various forms of data, thereby enabling such models to perform tasks that require understanding and synthesis across multiple modalities. Examples of MLLMs include Open AI's GPT-4 Turbo with Vision and Open AI's Contrastive Language-Image Pre-training (CLIP).

As such, as described herein, the meeting insight generator 228, in the form of an LLM, LVM, and/or MLLM, can obtain a prompt and, using such information in the prompt, generate a meeting insight(s), for instance, in the form of an inquiry response and/or orchestration directive. In some embodiments, the meeting insight generator 228 takes on the form of an LLM, LVM, and/or MLLM, but various other AI models can additionally or alternatively be used.

Use of LLM, LVM, and/or MLLM may depend on the format of the data to be analyzed and/or the meeting insight to be generated. As one example, prompts including only text may be processed via an LLM, and prompts including images may be processed via an LVM and/or MLLM. In some cases, text-based prompts and visual-based prompts may be generated separately such that the text-based prompts are processed by an LLM, while the visual-based prompts are processed via an LVM or MLLM. In other cases, prompts with a visual aspect may be directed to an MLLM. In this way, an MLLM may process both the text-based data and the visual-based data. Accordingly, although the meeting insight generator 228 is illustrated as a single component, any number of components may be used to create content. Further, although the meeting insight generator 228 is illustrated as incorporated with the meeting manager 212, the meeting insight generator 228 may be separate or distinct from the meeting manager 212 (e.g., as a separate service or incorporated with another system or component).

The meeting insight manager 230 is generally configured to manage the generated meeting insights. In this regard, meeting insights generated via the meeting insight generator 228 may be managed and/or transmitted by the meeting insight manager 230. In some cases, in accordance with the meeting insight generator 228 generating a meeting insight(s), the meeting insight(s) 250 may be stored, for example, in data store 214, for use in facilitating management of a live meeting or subsequent meeting, etc. Additionally or alternatively, meeting insight(s) 250 may be provided to a user device or user for viewing, such as via user device 110 of FIG. 1, or another component for viewing or performing further analysis. In this way, a meeting insight may be presented to one or more meeting participants during a live meeting.

Further, the meeting insight manager 230 may use a meeting insight produced or output by the meeting insight generator 228 to generate or derive additional content. For instance, in some cases, the meeting insight may be aggregated with other meeting insights. For example, in identifying an inquiry response in association with an inquiry, the inquiry response may be combined with another inquiry response to present an aggregate response. As another example, orchestration directives may be generated for different portions or aspects of a meeting. In this regard, orchestration directives may be aggregated or compiled to generate a final set of orchestration directives.

As another example, the meeting insight manager 230 may compare different meeting insights to one another and provide a suggestion or recommendation for a particular meeting insight to be delivered to a meeting participant or set of meeting participants. For instance, effectiveness (e.g., represented via a score or ranking) associated with multiple generated inquiry responses may be compared to one another or ranked, and the highest effective inquiry response may be recommended or suggested for use.

In some embodiments, the meeting insight manager 230 may analyze the meeting insight and initiate a new or different meeting insight generation. For instance, based on a response to a first prompt or user feedback associated with the response, the meeting insight manager 230 may trigger the prompt generator to generate a new prompt with a different instruction or based on different contextual data. For instance, upon determining a first orchestration directive, a second orchestration directive may be initiated. Determining a scope for a new or different prompt, such as a different instruction or different contextual data, may be performed in any number of ways. In some cases, a pattern, template, or hierarchical structure may be employed to identify a subsequent set of contextual data to use in generating meeting insights. As another example, a pattern, template, or hierarchical structure may be employed to identify a subsequent predetermined template to use for generating a subsequent prompt (e.g., upon using a first template to generate an orchestration directive, a second template may be used to generate a subsequent orchestration directive, and so on). In other cases, AI technology may be used to facilitate generation of a subsequent relevant contextual data scope and/or instructions to pursue.

Meeting insight(s) 250 may be presented, via a user interface, in any number of ways. As one example, a meeting insight may be presented in association with an inquiry, a management event, and orchestration directive, contextual data, a score (e.g., effectiveness score), etc. In this way, a user interface may present a meeting insight generated in association with an identified inquiry event and/or orchestration event. In some cases, a meeting insight may be presented in a meeting insight panel. For example, a meeting insight panel may be presented adjacent to a panel that includes representations of one or more meeting participants. In some cases, meeting insights may be presented in a chat panel (e.g., text-based messaging among participants), for example, adjacent to the participant panel that includes the representations of meeting participants (e.g., video feeds, names, and/or avatars).

As can be appreciated, any number or type of meeting insights may be generated, and embodiments described herein are not intended to limit the type of meeting insight that may be requested or produced via AI technology. Further, meeting insights may be presented in any number of ways. Any number of implementations may be employed in accordance with embodiments described herein.

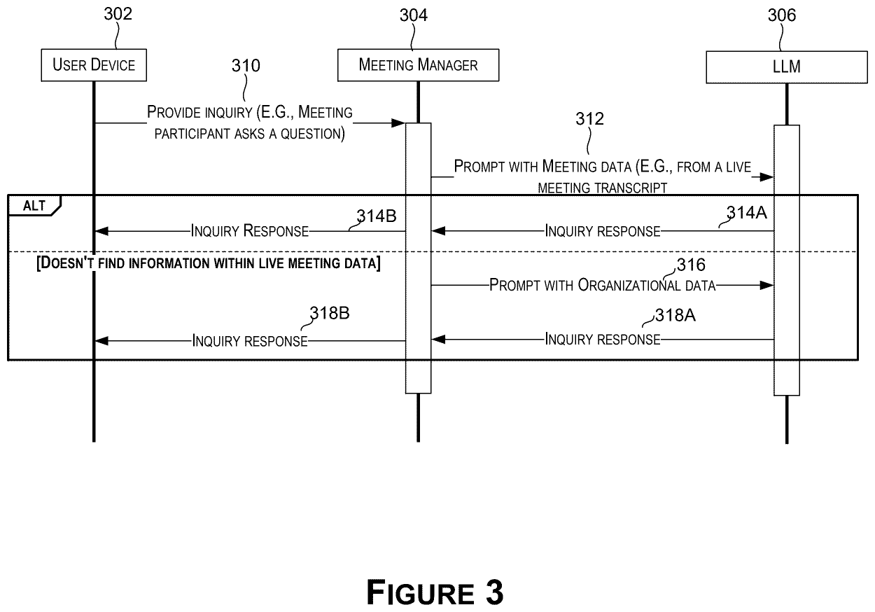

Turning to FIG. 3, FIG. 3 provides an example flow for generating an inquiry response, in accordance with embodiments described herein. As shown in FIG. 3, assume a live meeting is being conducted via a virtual meeting platform. Further assume a meeting participant operating a user device 302 provides 310 an inquiry. In some cases, an inquiry may be provided via a text input tool. In other cases, an inquiry may be asked during the live meeting. Examples of inquiries may include “What was the due date for my task?,” “Are there any suggestions for addressing the errors in task A?,” “What is the release date of the product?,” or the like.

The meeting manager 304 may obtain the inquiry from the user device 302. Based on an inquiry event (e.g., obtaining the inquiry), the meeting manager 304 may identify contextual data relevant to the inquiry. In one embodiment, the meeting manager 304 may identify contextual data in the form of meeting data. For example, the meeting manager 304 may identify contextual data in a live meeting transcript that is relevant to the inquiry. Such contextual data may be identified via a search of the live meeting transcript. In such a case, the meeting manager 304 may provide 312 a prompt that includes the contextual data from the live meeting transcript along with an instruction to generate an inquiry response for the inquiry using the live meeting data. As shown, the prompt is provided 312 as input to the LLM 306. In such a case, the LLM 306 may use the contextual data to generate an inquiry response that is provided 314A to the meeting manager 304 to communicate 314B to the user device 302. In this illustrative example, assume contextual data in not identified in association with meeting data (e.g., live meeting data). In such a case, the meeting manager 304 may identify contextual data in the form of organizational data. For example, the meeting manager 304 may identify contextual data in documents or communications associated with a meeting participant or a team of individuals. In such a case, the meeting manager 304 may provide 316 a prompt that includes the contextual data from the organizational data along with an instruction to generate an inquiry response for the inquiry using the organizational data. As shown, the prompt is provided 316 as input to the LLM 306. Thereafter, the LLM 306 may use the contextual data to generate an inquiry response that is provided 318A to the meeting manager 304 to communicate 318B to the user device 302.

FIG. 3 provides only an example and many different configurations and implementations may be used. For example, in some cases, different types of contextual data may be identified, which are then used to generate an inquiry response. For instance, live meeting data, prior meeting data, and organizational data may all be identified to include contextual data relevant to the inquiry. In some cases, a single prompt with the different types of contextual data may be provided to the LLM to generate an inquiry response. In other cases, multiple prompts may be generated to convey the different types of contextual data (e.g., a prompt for the live meeting data, a prompt for the prior meeting data, and a prompt for the organizational data). As another example, in some cases, the type of contextual data identified for use in generating an inquiry response may be performed concurrently. In other cases, the type of contextual data may be identified in a sequential order. For example, contextual live meeting data may first be identified and, if no relevant live meeting data is identified, contextual prior meeting data may be identified, etc.

Further, implementations may include various configuration of components. For example, although meeting manager 304 is illustrated separate from the LLM 306, in other cases, the LLM 306 may be included as part of the meeting manager 304. Further, contextual data identification or retrieval and/or prompt generation may be performed by a different component.

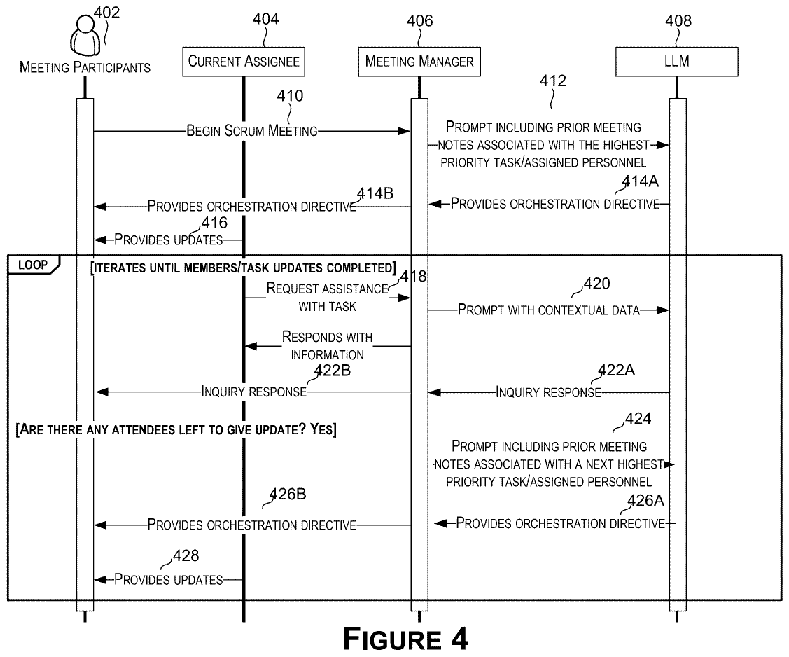

Turning to FIG. 4, FIG. 4 provides an example flow for generating an orchestration directive, in accordance with embodiments described herein. Assume a set of meeting participants 402 operating various user devices are attendees of a virtual scrum meeting, and the beginning of the meeting is initiated 410. The meeting manager 406 may identify the meeting initiation as an orchestration event. Based on the orchestration event (e.g., initiation of the meeting), the meeting manager 406 may identify relevant contextual data relevant to the orchestration event. In one embodiment, the meeting manager 406 may identify contextual data in the form of prior meeting data. For example, the meeting manager 406 may identify contextual data from prior scrum meeting notes associated with a highest priority task and the assigned individual. In this way, as the orchestration event is initiation of the meeting, a search of prior meeting notes may be performed to identify data associated with the highest priority task and the assigned personnel. In some cases, a highest priority task may be designated as such in the prior meeting notes. In other cases, a highest priority task may be automatically determined based on a preference (e.g., user preference). For example, prioritization of tasks may be based on a due date or deadline, a time duration to perform a task, a number of individuals working on the task, a cost or revenue associated with a task, etc. Such a priority preference may be a default preference, a user specified preference, and/or the like. By way of example, in accordance with initiation of a meeting, the meeting manager 406 may analyze live meeting notes and/or prior meeting notes to identify a highest task priority based on a nearest due date and a corresponding team member(s) assigned to the task. Accordingly, such contextual data may be identified via a search of meeting notes (e.g., prior meeting notes). As described, the meeting notes may be organized or structured in a manner that facilitates an efficient search for data (e.g., headings, dates, assignments, etc.). Additionally or alternatively, contextual data may be identified in association with organizational data.

In association with identifying contextual data, the meeting manager 406 may provide 412 a prompt that includes the contextual data, for example, from the meeting notes associated with a highest priority task and assigned personnel along with an instruction to generate an orchestration directive for the meeting using the data. In some cases, the prompt may be generated using a template or predetermined prompt. In this way, the prompt may include various aspects, such as an instruction, with fillable portions to include or replace default values. For instance, the particular task, the due date, and/or the individual assigned to the task may be input into a predetermined prompt associated with an orchestration event.

As shown, the prompt is provided 412 as input to the LLM 408. In such a case, the LLM 408 may use the contextual data to generate an orchestration directive that is provided 414A to the meeting manager 406 to communicate 414B to the meeting participants 402. In this example, the orchestration directive may include a prompt or instruction indicating an assignee with the highest priority task to provide updates for the task. In this example, the orchestration directive is provided to all meeting participants. In other examples, the orchestration directive may be provided to the specific meeting participant(s) to which the orchestration directive is relevant (e.g., the assignee with the highest priority task).

In this illustrative example, assume the current assignee 404 provides an update during the meeting to the other meeting participants. Such an update may be provided 416 in a verbal or textual form.

In some cases, the current assignee 404 may ask a question or request 418 assistance with a task. In such cases, the meeting manager 406 may identify an inquiry event related to a task being worked on by the current assignee 404. In such a case, the meeting manager 406 may identify contextual data in the form of meeting data and/or organizational data. For example, the meeting manager 406 may identify contextual data in organizational data, such as documents or communications associated with a meeting participant or a team of individuals. In such a case, the meeting manager 406 may provide 420 a prompt that includes the contextual data (e.g., from the organizational data) along with an instruction to generate an inquiry response for the inquiry using the contextual data. As shown, the prompt is provided 420 as input to the LLM 408. Thereafter, the LLM 408 may use the contextual data to generate an inquiry response that is provided 422A to the meeting manager 406 to communicate 422B to the meeting participants 402.

In accordance with the current assignee 404 completing a status update associated with a task, the meeting manager 406 may identify an orchestration event related to completion of a status update by the current assignee 404. Based on the orchestration event (e.g., completion of a status update), the meeting manager 406 may identify contextual data relevant to the orchestration event. In one embodiment, the meeting manager 406 may identify contextual data in the form of prior meeting data. For example, the meeting manager 406 may identify contextual data from prior scrum meeting notes associated with a next highest priority task and the assigned individual. In this way, a search of prior meeting notes may be performed to identify data associated with a next highest priority task and the assigned personnel. In some cases, a next highest priority task may be designated as such in the prior meeting notes. In other cases, a next highest priority task may be automatically determined based on a preference (e.g., user preference). For example, prioritization of tasks may be based on a due date or deadline, a time duration to perform a task, a number of individuals working on the task, a cost or revenue associated with a task, etc. Such a priority preference may be a default preference, a user specified preference, and/or the like. By way of example, in accordance with a completion of a status update associated with a highest priority task, the meeting manager 406 may analyze live meeting notes and/or prior meeting notes to identify a next highest task priority based on a next nearest due date and a corresponding team member(s) assigned to the task. Accordingly, such contextual data may be identified via a search of meeting notes (e.g., prior meeting notes). As described, the meeting notes may be organized or structured in a manner that facilitates an efficient search for data (e.g., headings, dates, assignments, etc.). Additionally or alternatively, contextual data may be identified in association with organizational data.

In association with identifying contextual data, the meeting manager 406 may provide 424 a prompt that includes the contextual data, for example, from the meeting notes associated with a highest priority task and assigned personnel along with an instruction to generate an orchestration directive for the meeting using the data. In some cases, the prompt may be generated using a template or predetermined prompt. In this way, the prompt may include various aspects, such as an instruction, with fillable portions to include or replace default values. For instance, the particular task, the due date, and/or the individual assigned to the task may be input into a predetermined prompt associated with an orchestration event.

As shown, the prompt is provided 424 as input to the LLM 408. In such a case, the LLM 408 may use the contextual data to generate an orchestration directive that is provided 426A to the meeting manager 406 to communicate 426B to the meeting participants 402. In this example, the orchestration directive may include a prompt or instruction indicating a new assignee with the next highest priority task (e.g., based on a next due date) to provide updates for the task. In this example, the orchestration directive is provided to all meeting participants. In other examples, the orchestration directive may be provided to the specific meeting participant(s) to which the orchestration directive is relevant (e.g., the assignee with the highest priority task). Based on the orchestration directive 426B, the current assignee 404 provides 428 an update during the meeting to the other meeting participants. Such an update may be provided 416 in a verbal or textual form.

This iterative process or loop of triggering status updates for sequentially prioritized tasks may continue until each of the tasks has been addressed, each meeting participant has provided a status update, the meeting has ended, and/or the like. Further, although shown as the LLM generating the orchestration directive, in some embodiments, an LLM is not needed to generate an orchestration directive. For instance, upon detecting completion of a first task status, a prompt to initiate discussion of a next task status may be triggered via meeting manager 406. As one example, in some cases, rules, algorithms, models, templates, etc. may be employed in association with the meeting manager 406 to facilitate meeting management. In other cases, an LLM may be initially referenced (e.g., at the start of the meeting) and, thereafter, the sequential process is triggered without further access to the LLM with regard to meeting management.

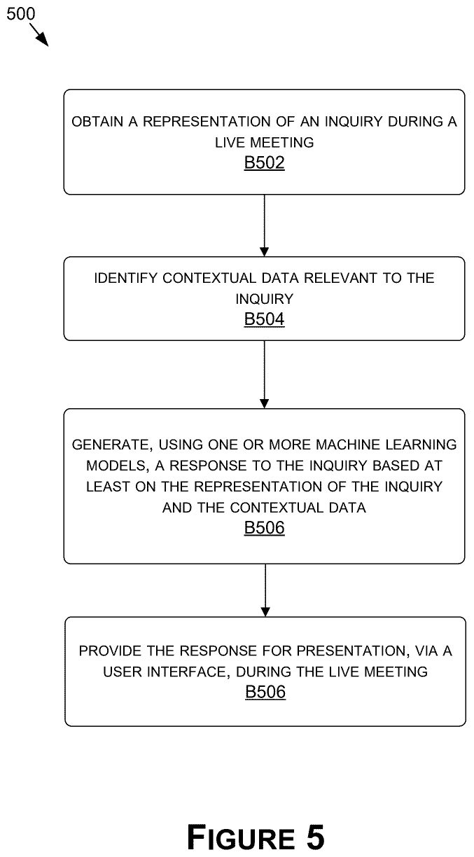

Now referring to FIGS. 5-7, each block of methods 500, 600, and 700 described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, methods 500, 600, and 700 are described, by way of example, with respect to the system of FIG. 1 and FIG. 2. However, this method may additionally or alternatively be executed by any one system, or any combination of systems, including, but not limited to, those described herein.

FIG. 5 is a flow diagram showing a method 500 for facilitating management of live meetings, in accordance with some embodiments of the present disclosure. The method 500, at block B502, includes obtaining a representation of an inquiry during a live meeting. An inquiry may be provided via a text box of the user interface, for example. In some cases, the representation of the inquiry may be generated based on a verbal inquiry provided during the live meeting.

The method 500, at block B504, includes identifying contextual data relevant to the inquiry. Contextual data may be data associated with a live meeting, data associated with a prior meeting, and/or data associated with an organization. In some embodiments, identifying contextual data relevant to an inquiry comprises retrieving the contextual data from a data source based on a representation of the inquiry

The method 500, at block B506, includes generating, using one or more machine learning models, a response to the inquiry based at least on the representation of the inquiry and the contextual data. In some embodiments, a response to the inquiry is generated by generating a prompt based on the representation of the inquiry and the contextual data relevant to the inquiry and, thereafter, providing the prompt as input to a machine learning model, such as and LLM. In some cases, the contextual data is appended to the prompt.

The method 500, at block B508, includes providing the response for presentation, via a user interface, during the live meeting. In some cases, the response may be provided via a visual presentation and/or an audio presentation.

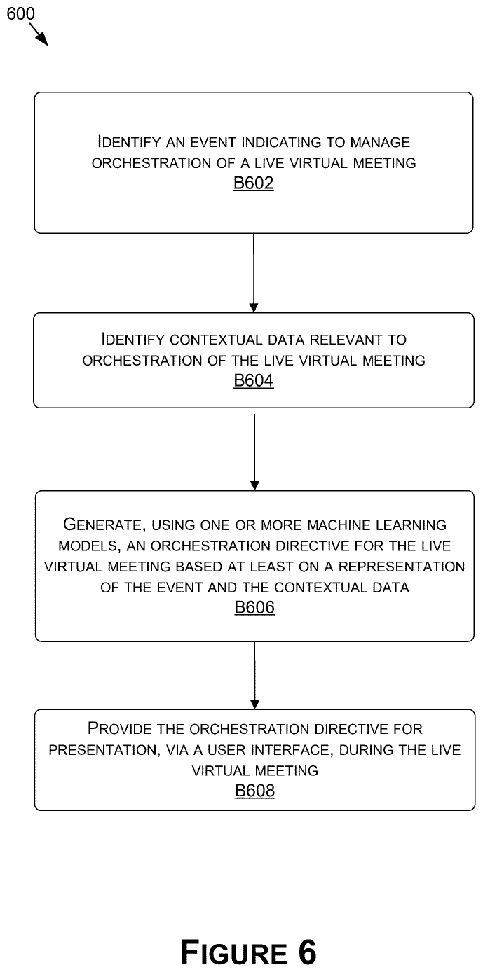

FIG. 6 provides a flow diagram showing a method 600 for facilitating management of live meetings, in accordance with some embodiments of the present disclosure. The method 600, at block B602, includes identifying an event indicating to manage orchestration of a live virtual meeting. In embodiments, an event indicating to manage orchestration of a live virtual meeting may include initiation of a meeting or concluding a segment or portion of the meeting. For example, a meeting participant completing a status update associated with a task may be identified as an orchestration event.

The method 600, at block B604, includes identifying contextual data relevant to orchestration of the live virtual meeting. Contextual data may include a meeting participant, a task, a due date, or a combination thereof. Contextual data may be obtained from live meeting data, prior meeting data, and/or organizational data. In some cases, identifying contextual data may include searching prior meeting notes to identify a prioritized task and a meeting participant associated therewith. Identifying a prioritized task may be based on any number of features, such as a due date, or other aspect that may be prioritized.

The method 600, at block B606, includes generating, using one or more machine learning models, an orchestration directive for the live virtual meeting based at least on a representation of the event and the contextual data.

The method 600, at block B608, includes providing the orchestration directive for presentation, via a user interface, during the live virtual meeting. In embodiments, the orchestration directive may be an instruction or a prompt provided to meeting participants to initiate a subsequent segment of the live virtual meeting.

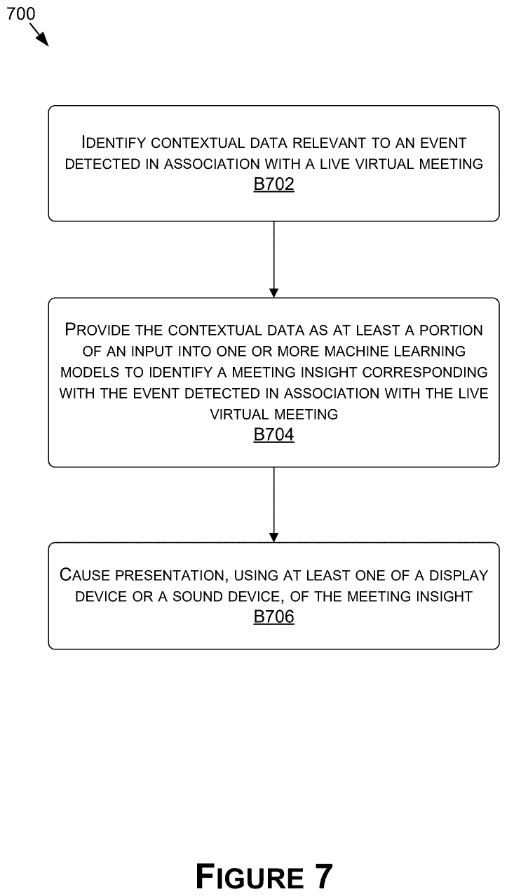

Turning to FIG. 7, FIG. 7 provides a flow diagram showing a method 700 for facilitating management of live meetings, in accordance with some embodiments of the present disclosure. The method 700, at block B702, includes identifying contextual data relevant to an event detected in association with a live virtual meeting. In embodiments, an event may be an inquiry event indicating to generate a meeting insight in the form of an inquiry response. In other embodiments, an event may be an orchestration event indicating to generate a meeting insight in the form of an orchestration directive. Such contextual data may be identified from a set of live meeting data, a set of prior meeting data, and/or a set of organizational data. The method 700, at block B702, includes providing the contextual data as at least a portion of an input into one or more machine learning models to identify a meeting insight corresponding with the event detected in association with the live virtual meeting. In embodiments, the contextual data may be included in a prompt that is provided as input into a LLM. The method 700, at block B704, includes causing presentation, using at least one of a display device or a sound device, of the meeting insight. A meeting insight may be in the form of an inquiry response related to an inquiry posed by a meeting attendee or an orchestration directive to guide the flow of the live meeting.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, aid in collaboration or team efforts among teams, and/or personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

### EXAMPLE LANGUAGE MODELS

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein - may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 8A is a block diagram of an example generative language model system 800 suitable for use in implementing at least some embodiments of the present disclosure. In the example illustrated in FIG. 8A, the generative language model system 800 includes a retrieval augmented generation (RAG) component 892, an input processor 805, a tokenizer 810, an embedding component 820, plug-ins/APIs 895, and a generative language model (LM) 830 (which may include an LLM, a VLM, a multi-modal LM, etc.).

At a high level, the input processor 805 may receive an input 801 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 830 (e.g., LLM/VLM/MMLM/etc.). In some embodiments, the input 801 includes plain text in the form of one or more sentences, paragraphs, and/or documents. Additionally or alternatively, the input 801 may include numerical sequences, precomputed embeddings (e.g., word or sentence embeddings), and/or structured data (e.g., in tabular formats, JSON, or XML). In some implementations in which the generative LM 830 is capable of processing multi-modal inputs, the input 801 may combine text (or may omit text) with image data, audio data, video data, design data, USD data, and/or other types of input data, such as but not limited to those described herein. Taking raw input text as an example, the input processor 805 may prepare raw input text in various ways. For example, the input processor 805 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 805 may remove stopwords to reduce noise and focus the generative LM 830 on more meaningful content. The input processor 805 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 892 (which may include one or more RAG models, and/or may be performed using the generative LM 830 itself) may be used to retrieve additional information to be used as part of the input 801 or prompt. RAG may be used to enhance the input to the LLM/VLM/MMLM/etc. with external knowledge, so that answers to specific questions or queries or requests are more relevant—such as in a case where specific knowledge is required. The RAG component 892 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 801 may be generated using the query or input to the model (e.g., a question, a request, etc.) in addition to data retrieved using the RAG component 892. In some embodiments, the input processor 805 may analyze the input 801 and communicate with the RAG component 892 (or the RAG component 892 may be part of the input processor 805, in embodiments) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 892 may retrieve a prior stored conversation history—or at least a summary thereof—and include the prior conversation history along with the current ask/request as part of the input 801 to the generative LM 830.

The RAG component 892 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 892 and the embeddings of the chunks along with the embeddings of the query may be compared to identify the most similar/related embeddings to the query, which may be supplied to the generative LM 830 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 892 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 810 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy may depend on factors such as the language being processed, the task at hand, and/or characteristics of the training dataset. As such, the tokenizer 810 may convert the (e.g., processed) text into a structured format according to tokenization schema being implemented in the particular embodiment.

The embedding component 820 may use any known embedding technique to transform discrete tokens into (e.g., dense, continuous vector) representations of semantic meaning. For example, the embedding component 820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data/video data/etc., the input processor 801 may resize the data to a standard size compatible with format of a corresponding input channel and/or may normalize pixel values to a common range (e.g., 0 to 1) to ensure a consistent representation, and the embedding component 820 may encode the image data using any known technique (e.g., using one or more convolutional neural networks (CNNs) to extract visual features). In some implementations in which the input 801 includes audio data, the input processor 801 may resample an audio file to a consistent sampling rate for uniform processing, and the embedding component 820 may use any known technique to extract and encode audio features—such as in the form of a spectrogram (e.g., a mel-spectrogram). In some implementations in which the input 801 includes video data, the input processor 801 may extract frames or apply resizing to extracted frames, and the embedding component 820 may extract features such as optical flow embeddings or video embeddings and/or may encode temporal information or sequences of frames. In some implementations in which the input 801 includes multi-modal data, the embedding component 820 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 830 and/or other components of the generative LM system 800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 820 may apply an encoded representation of the input 801 to the generative LM 830, and the generative LM 830 may process the encoded representation of the input 801 to generate an output 890, which may include responsive text and/or other types of data.

As described herein, in some embodiments, the generative LM 830 may be configured to access or use—or capable of accessing or using—plug-ins/APIs 895 (which may include one or more plug-ins, application programming interfaces (APIs), databases, data stores, repositories, etc.). For example, for certain tasks or operations that the generative LM 830 is not ideally suited for, the model may have instructions (e.g., as a result of training, and/or based on instructions in a given prompt, such as those retrieved using the RAG component 892) to access one or more plug-ins/APIs 895 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 895 to the plug-in/API 895, the plug-in/API 895 may process the information and return an answer to the generative LM 830, and the generative LM 830 may use the response to generate the output 890. This process may be repeated—e.g., recursively—for any number of iterations and using any number of plug-ins/APIs 895 until an output 890 that addresses each ask/question/request/process/operation/etc. from the input 801 can be generated. As such, the model(s) may not only rely on its own knowledge from training on a large dataset(s) and/or from data retrieved using the RAG component 892, but also on the expertise or optimized nature of one or more external resources—such as the plug-ins/APIs 895.

FIG. 8B is a block diagram of an example implementation in which the generative LM 830 includes a transformer encoder-decoder. For example, assume input text such as “Who discovered gravity” is tokenized (e.g., by the tokenizer 810 of FIG. 8A) into tokens such as words, and each token is encoded (e.g., by the embedding component 820 of FIG. 98A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 835 of the generative LM 830.

In an example implementation, the encoder(s) 835 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 840 may convert the context vector into attention vectors (keys and values) for the decoder(s) 845.

In an example implementation, the decoder(s) 845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 835, in an example transformer architecture, each token (e.g., word) flows through a separate path in the decoder(s) 845. During a first pass, the decoder(s) 845, a classifier 850, and a generation mechanism 855 may generate a first token, and the generation mechanism 855 may apply the generated token as an input during a second pass. The process may repeat in a loop, successively generating and adding tokens (e.g., words) to the output from the preceding pass and applying the token embeddings of the composite sequence with positional encodings as an input to the decoder(s) 845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 835, except that it creates its queries from the layer below it and takes the keys and values (e.g., matrix) from the output of the encoder(s) 835.

As such, the decoder(s) 845 may output some decoded (e.g., vector) representation of the input being applied during a particular pass. The classifier 850 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 855 may select or sample a word or token based on a corresponding predicted probability (e.g., select the word with the highest predicted probability) and append it to the output from a previous pass, generating each word or token sequentially. The generation mechanism 855 may repeat the process, triggering successive decoder inputs and corresponding predictions until selecting or sampling a symbol or token that represents the end of the response, at which point, the generation mechanism 855 may output the generated response.

FIG. 8C is a block diagram of an example implementation in which the generative LM 830 includes a decoder-only transformer architecture. For example, the decoder(s) 860 of FIG. 8C may operate similarly as the decoder(s) 845 of FIG. 8B except each of the decoder(s) 860 of FIG. 8C omits the encoder-decoder self-attention layer (since there is no encoder in this implementation). As such, the decoder(s) 860 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 860. As with the decoder(s) 845 of FIG. 8B, each token (e.g., word) may flow through a separate path in the decoder(s) 860, and the decoder(s) 860, a classifier 865, and a generation mechanism 870 may use auto-regression to sequentially generate one token at a time until predicting a symbol or token that represents the end of the response. The classifier 865 and the generation mechanism 870 may operate similarly as the classifier 850 and the generation mechanism 855 of FIG. 8B, with the generation mechanism 870 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### EXAMPLE COMPUTING DEVICE

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). As such, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that allow the computing device 900 to communicate with other computing devices via an electronic communication network, included wired and/or wireless communications. The communication interface 910 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may allow the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that allow detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to allow the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### EXAMPLE DATA CENTER

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may use distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments - in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
obtain a representation of an inquiry during a live meeting;
identify contextual data relevant to the inquiry;
generate, using one or more generative language models, a response to the inquiry based at least on the representation of the inquiry and the contextual data; and
provide the response for presentation, via a user interface, during the live meeting.

2. The one or more processors of claim 1, wherein the inquiry is provided via a text box of the user interface.

3. The one or more processors of claim 1, wherein the representation of the inquiry is generated based at least on a verbal inquiry provided during the live meeting.

4. The one or more processors of claim 1, wherein the contextual data comprises at least one of data associated with a live meeting transcript, data associated with a prior meeting, or data associated with an organization.

5. The one or more processors of claim 1, wherein the identifying contextual data relevant to the inquiry comprises retrieving the contextual data from at least one data source based at least on the representation of the inquiry.

6. The one or more processors of claim 1 further comprising:
generating a prompt based at least on the representation of the inquiry and the contextual data relevant to the inquiry; and
providing the prompt as input to the one or more generative language models.

7. The one or more processors of claim 1, wherein the contextual data identified as relevant to the inquiry is appended to a prompt that is generated based on the representation of the inquiry and that is provided as input to the one or more generative language models.

8. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

9. A system comprising one or more processors to:
identify an event indicating to manage orchestration of a live virtual meeting;
identify contextual data relevant to orchestration of the live virtual meeting;
generate, using one or more generative language models, an orchestration directive for the live virtual meeting based at least on a representation of the event and the contextual data; and
provide the orchestration directive for presentation, via a user interface, during the live virtual meeting.

10. The system of claim 9, wherein the event comprises an initiation of the live virtual meeting, and the contextual data comprises at least one of a meeting participant, a task, or a due date.

11. The system of claim 9, wherein the event comprises a completion of a meeting participant update, and the contextual data comprises at least one of a subsequent meeting participant, a subsequent task, or a subsequent due date.

12. The system of claim 9, wherein the contextual data comprises at least one of data associated with a live meeting, data associated with a prior meeting, or data associated with an organization.

13. The system of claim 9, wherein the orchestration directive comprises an instruction or a prompt provided to meeting participants to initiate a subsequent segment of the live virtual meeting.

14. The system of claim 9, wherein the identifying contextual data comprises searching prior meeting notes to identify a prioritized task and a meeting participant associated therewith.

15. The system of claim 9, wherein the identifying contextual data comprises searching prior meeting notes to identify a prioritized task based on a due date associated therewith.

16. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

17. A method comprising:
identifying contextual data relevant to an event detected in association with a live virtual meeting;
providing the contextual data as at least a portion of an input into one or more generative language models to identify a meeting insight corresponding with the event detected in association with the live virtual meeting; and
causing presentation, using at least one of a display device or an audio device, of the meeting insight.

18. The method of claim 17, wherein the input includes a prompt and the one or more generative language models includes at least one of a large language model (LLM), a vision language model (VLM), or a multi-modal language model (MMLM), and wherein the contextual data includes at least one of live meeting data, prior meeting data, or organizational data identified as relevant to an inquiry.

19. The method of claim 17, wherein the input includes a prompt and the one or more generative language models includes at least one of a large language model (LLM), a vision language model (VLM), or a multi-modal language model (MMLM), and wherein the contextual data includes at least one of live meeting data, prior meeting data, or organizational data identified as relevant to an orchestration event.

20. The method of claim 17, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
